(19) United States
(12) Patent Application Publication
(10) Pub. No.: US 2019/0067948 A1
(43) Pub. Date: Feb. 28, 2019

(54) SYSTEM AND METHOD FOR INTEGRALLY MANAGING ELECTRIC ENERGY

(71) Applicant: OCI COMPANY LTD., Seoul (KR)

(72) Inventors: Woo Young CHOI, Seongnam-si (KR); Young Il KIM, Seongnam-si (KR); Cha Ho AHN, Seongnam-si (KR); Jin Sun YANG, Seongnam-si (KR)

(21) Appl. No.: 15/704,451

(22) Filed: Sep. 14, 2017

(30) Foreign Application Priority Data
Aug. 28, 2017 (KR) 10-2017-0108505

(51) Int. Cl. H02J 3/38; H02S 50/00; H02J 7/35; H02J 7/00

(52) U.S. Cl. CPC H02J 3/383; H02S 50/00; H02S 40/38; H02J 7/0068; H02J 7/35

(57) ABSTRACT

Disclosed herein are a system and a method for integrally managing electric energy. The system includes a power generation unit configured to generate electric energy by photovoltaic generation, a battery unit configured to charge batteries therein with the electric energy from the power generation unit or electric energy from an external power source or to discharge the electric energy to a load, and an integrated management controller configured to control an energy transfer path of the power generation unit and the charging/discharging of the battery unit according to a predetermined power utilization algorithm and to support a user interface so that energy management status is monitored thereon.

### CROSS-REFERENCE TO RELATED APPLICATIONS

This application claims the priority of Korean Patent Application No. 10-2017-0108505 filed on Aug. 28, 2017, in the Korean Intellectual Property Office, the disclosure of which is hereby incorporated by reference in its entirety.

### BACKGROUND

### 1. Technical Field

The present disclosure relates to a system and a method for integrally managing total power flow of photovoltaic generation, stored energy, energy supplied to a load, and an external power source while reducing risk due to time synchronization and loss of communications.

### 2. Description of the Related Art

Recently, distributed energy resources including a combination of renewable energy such as solar light, energy storage devices, electric vehicles, and intelligent loads have been developed. Accordingly, there are increasing demands for a change in the existing energy utilization scheme using energy systems employing a centralized operation mechanism.

In particular, according to the existing centralized energy management system, electric energy is supplied to load devices for households or industrial applications through a power system to which a transmission line of a power plant is connected, while electric energy generated using solar light or the like is utilized only through a separate energy market.

Therefore, even in a centralized energy management system, the external energy received from an external power source from a transmission line or the like, the energy stored in a battery, the energy supplied to a load for households or industrial applications, the energy generated by the system internally by photovoltaic generation or the like have been all measured and managed separately.

Accordingly, previously, even in a microgrid energy management system, there were complicated communication lines via which measurement information and control information for external energy, stored energy, and the energy generated internally are transmitted. When such complicated communications lines and a large number of communications modules such as hubs are employed, there are problems such as errors including loss of communications, and the risk due to the time synchronization between different communication modules.

For example, if signals are lost between the communications modules or an error occurs on time synchronization, energy measurement and control information for acquiring or transmitting are distorted inevitably, and errors due to time delays may also be accumulated. When this happens, errors occur in performing an power utilization algorithm in the energy management system, and thus the reliability of the energy management system may be significantly deteriorated.

In order to cope with the problems resulted from the erroneous operation of the energy management system or the delay error, the management function and the power utilization algorithm for the external energy, the stored energy and the energy internally generated have to be limited. In particular, as the communications lines become more complicated and the number of the communications modules increases, the maintenance also comes hard, resulting in increase in the management cost.

### SUMMARY

It is an object of the present disclosure to provide a system and a method for integrally managing electric energy that reduce the risk due to time synchronization and loss of communications to thereby easily connect a variety of elements with one another or integrally managing them.

Particularly, in the case of a stand-alone type or a linked type microgrid architecture, the number of communications lines for transmitting and receiving various sensing information, control information, management information, etc. is reduced, thereby simplifying the configurations of the communication modules and the time synchronization units.

It is another object of the present disclosure to provide a system and a method for integrally managing electric energy that can efficiently and integrally manage the energy by photovoltaic generation, the stored energy, the energy supplied to the load and the energy received from an external power source in the respective management modules.

It is yet another object of the present disclosure to provide a system and a method for integrally managing electric energy that support so that various management schemes and power utilization algorithms can be selected appropriately so as to manage the energy by photovoltaic generation, the stored energy, the energy supplied to the load, the energy received from an external power source, etc. can be managed efficiently.

In accordance with one aspect of the present disclosure, a system for integrally managing electric energy includes: a power generation unit configured to generate electric energy by photovoltaic generation; a battery unit configured to charge batteries therein with the electric energy from the power generation unit or electric energy from an external power source or to discharge the electric energy to a load; and an integrated management controller configured to control an energy transfer path of the power generation unit and the charging/discharging of the battery unit according to a predetermined power utilization algorithm and to support a user monitoring unit so that energy management status is monitored thereon.

According to an exemplary embodiment of the present disclosure, risk due to time synchronization and loss of communications can be reduced such that a variety of elements can be easily connected with one another or integrally managed. According to another exemplary embodiment of the present disclosure, the number of communications lines for transmitting and receiving sensing information, control information and management information can be reduced, such that the elements such as the communications modules and synchronization units can be simplified. As a result, the cost for management and maintenance can be saved, and the manpower for managing electric energy can be reduced.

In addition, according to the exemplary embodiments of the present disclosure, it is possible to integrally and efficiently manage the energy generated by photovoltaic generation, the stored energy, the energy supplied to the load, and the energy supplied from the external power source, to further improve the accuracy and reliability. In particular, by appropriately selecting and applying energy management and utilization algorithms, it is possible to increase the efficiency of the energy management and to thereby increase the gain.

### BRIEF DESCRIPTION OF DRAWINGS

FIG. 1 is a block diagram showing a system for integrally managing electric energy according to an exemplary embodiment of the present disclosure;

FIG. 2 is a block diagram showing the integrated management control unit specifically shown in FIG. 1; and

FIG. 3 is a block diagram showing a plurality of system for integrally managing electric energy connected to one another.

### DETAILED DESCRIPTION

The above objects, features and advantages will become apparent from the detailed description with reference to the accompanying drawings. Embodiments are described in sufficient detail to enable those skilled in the art to easily practice the technical idea of the present disclosure. Detailed descriptions of well known functions or configurations may be omitted in order not to unnecessarily obscure the gist of the present disclosure. Hereinafter, exemplary embodiments of the present disclosure will be described in detail with reference to the accompanying drawings.

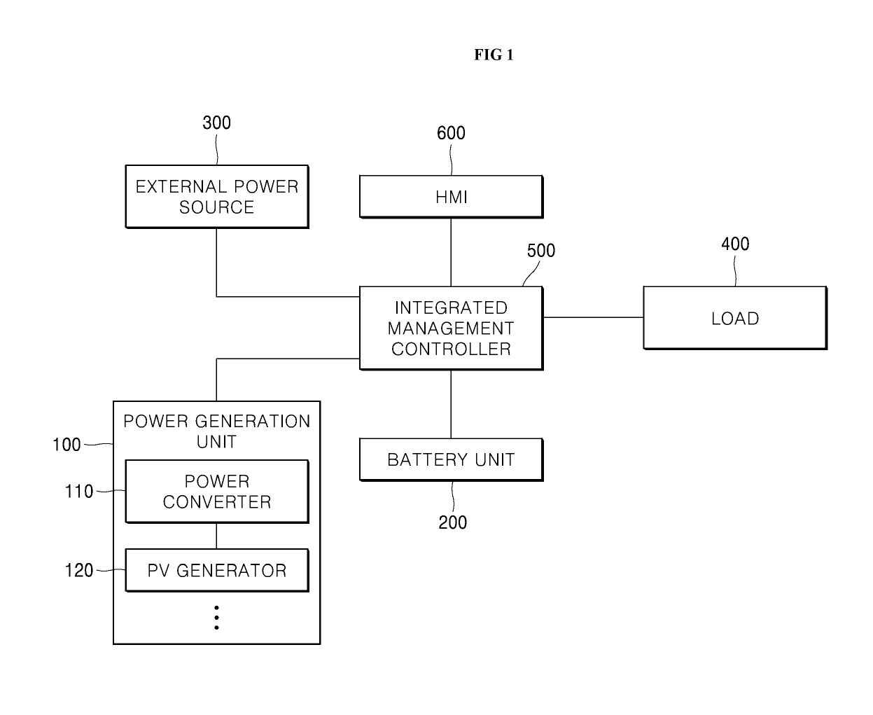

FIG. 1 is a block diagram showing a system for integrally managing electric energy according to an exemplary embodiment of the present disclosure.

The system shown in FIG. 1 includes a power generation unit 100 for generating electric energy by photovoltaic generation, a battery unit 200 for charging batteries therein with the electric energy from the power generation unit 100 and the electric energy from an external power source 300 or discharging them to a load 400, and an integrated management controller 500 for controlling an energy transmission path of the power generation unit 100 and charging/discharging energy to/from the battery unit 200 according to predetermined power utilization algorithm or energy management policy, and for supporting a user monitoring unit 600 so that the energy management status is monitored.

The power generation unit 100 generates electric energy by photovoltaic generation using one or more PV generators 120. In addition, the power generation unit 100 converts the electric energy, direct current (DC) generated from each of the PV generators 120 into an alternating current (AC) by using a power converter 110 such as an inverter.

In the PV generators 120, a plurality of photovoltaic panels, each of which generates electric energy. The power converter 110 converts the energy in the form of a DC source into an AC source, and transfers the energy to the battery unit 200 or the load 400 under the control of the integrated management controller 500.

The PV generators 120 may be replaced with other power generation sources, for example, renewable energy sources such as wind power, solar heat, small hydro power and biomass. Practically, it is preferable to employ PV panels as the power generation sources which are available in small customers or households considering the noise, smell and environmental factors.

The power generation unit 100 is a hybrid power control apparatus, and the DC voltage of the PV generators 120 may be converted into a DC link voltage by a converter. In order to transfer the energy from the PV generators 120 to the load 400, it may be necessary to convert the energy, DC link voltage into an AC voltage via the inverter. To this end, the hybrid power control apparatus may include at least one inverter and converter.

The battery unit 200 may include one or more batteries and may check the state-of-charge (SOC) of each of the batteries. For example, the battery unit 200 may include batteries such as Li-ion battery (LiB) and redox flow battery (RFB), and may further include a variety of sensors for measuring and calculating the SOC and open-circuit voltage (OCV) of the batteries. The battery unit 200 may charge the batteries therein (internal batteries) with the electric energy from the power generation unit 100 and the external power source 300 or discharge it to the load 400 or the external power source 300 under the control of the integrated management controller 500.

Specifically, upon receiving a control signal to charge batteries from the integrated management controller 500, the battery unit 200 charges the batteries with electric energy input from the power generation unit 100 and the external power source 300. In doing so, the battery unit 200 charges the batteries with some of the electric energy input from the power generation unit 100 and the external power source 300, leaving the portion of the electric energy reserved for the load 400. On the other hand, upon receiving a control signal to charge batteries from the integrated management controller 500, the battery unit 200 discharges electric energy in the batteries to transfer it to the external power source 300 or the load 400.

The external power source 300 may be an power management organization or an power-grid management organization that distributes and supplies the energy from power plants. The external power source 300 may transfer electric energy to the battery unit 200 or the load 400 or may receive electric energy from the battery unit 200.

The integrated management controller 500 controls and manages the electric energy supplied to the load 400 from the power generation unit 100, the electric energy charged in the battery unit 200, the electric energy supplied from the external power source 300 to the battery unit 200, and the electric energy transferred from the external power source 300 to the load 400 according to a preset power utilization algorithm or energy management policy,

In addition, the integrated management controller 500 supports the user monitoring unit 600 so that the currently managed energy management status can be monitored according to a predetermined power utilization algorithm or energy management policy.

Specifically, the integrated management controller 500 maps all of the information on the electric energy supplied to the load 400 from the power generation unit 100, information on the electric energy of the battery unit 200, information on the electric energy supplied from the battery unit 200 to the load 400, information on the electric energy supplied from the external power source 300 to the battery unit 200, information on the electric energy transfer from the external power source 300 to the load 400, and information sensed via a variety of sensors, Then, the mapped information and data are transmitted to and shared with the user monitoring unit 600, a separate supervisory control and data acquisition (SCADA), etc.

The user monitoring unit 600 displays various kinds of electric energy data, energy management information and sensing information provided from the integrated management controller 500 on a display device such as a monitor so that an administrator or a user can conveniently check the status. The user monitoring unit 600 may include the SCADA or may perform the functions of the SCADA.

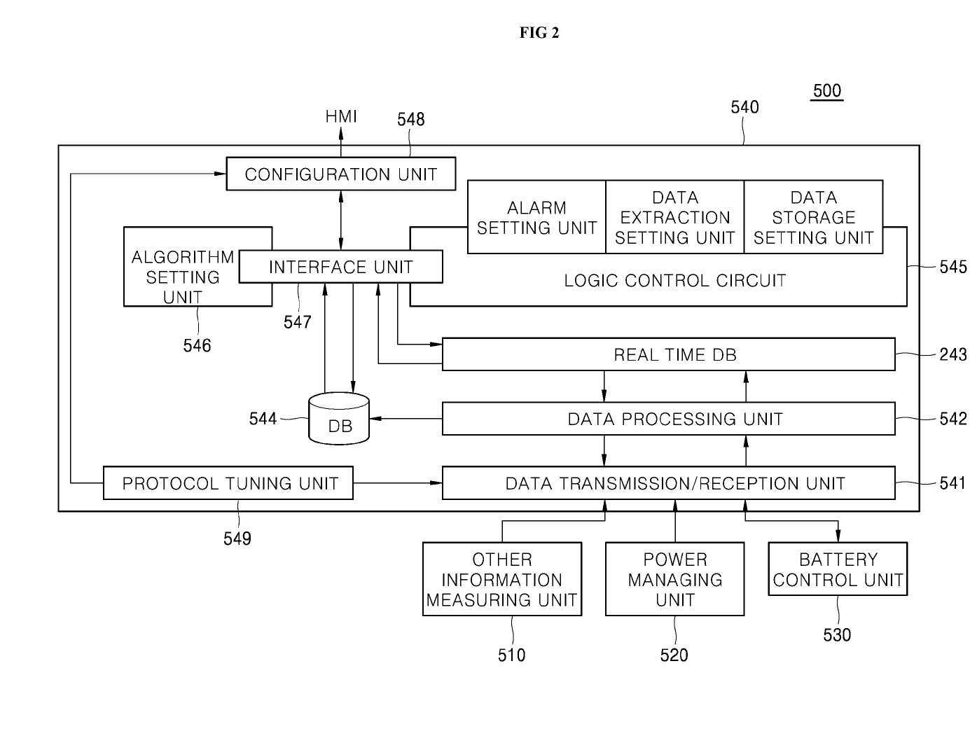

FIG. 2 is a block diagram showing the integrated management controller shown in FIG. 1.

The integrated management controller 500 shown in FIG. 2 includes an other information measuring unit 510, an power managing unit 520 for measuring the energy transmitted to the load 400 from the power generation unit 100 and the external power source 300, a battery control unit 530 for measuring the charged/discharged energy to/from the battery unit 200 and controlling the charging/discharging operation, and an energy operation control unit 540 for controlling the other information measuring unit 510, the energy managing unit 520 and the battery control unit 530 and for transmitting control status on the other information measuring unit 510, the energy managing unit 520 and the battery control unit 530.

The other information measuring unit 510 collects data derived from sensors such as a temperature sensor, a humidity sensor and a fire sensor, and detects the outputs. In addition, the other information measuring unit 510 transmits the detected output information to the energy operation control unit 540. The other information measuring unit 510 allows the energy converted in the power converter 110 to be supplied to the battery unit 200 to charge the batteries or to be transmitted to the load 400 to be consumed therein.

The energy managing unit 520 measures the electric energy supplied from the power generation unit 100 to the load 400 and the electric energy transferred from the external power source 300 to the load 400, and transmits the measured electric energy information to the energy operation control unit 540. The energy managing unit 520 measures the electric energy supplied from the power generation unit 100 to the load 400 and the electric energy transferred from the external power source 300 to the load 400 under the control of the energy operation control unit 540.

The battery control unit 530 detects the electric energy charged/discharged to/from the battery unit 200 in real time. The information on the charged/discharged electric energy to/from the battery unit 200 detected in real time is transmitted to the energy operation control unit 540. The battery control unit 530 controls the charging/discharging operation of the battery unit 200 under the control of the energy operation control unit 540.

The energy operation control unit 540 controls operations of, the energy managing unit 520, and the battery control unit 530 in real time according to a predetermined power utilization algorithm or energy management policy. In addition, the energy operation control unit 540 supports so that the control status of the other information measuring unit 510, the energy managing unit 520 and the battery control unit 530 can be monitored on the screen of the user monitoring unit 600. To this end, the energy operation control unit 540 transmits, to the user monitoring unit 600, measurement information, control status, and various sensing information of the other information measuring unit 510, the energy managing unit 520 and the battery control unit 530, which are controlled in real time. In doing so, the energy operation control unit 540 processes the measurement information, the control status and various sensing information according to the predetermined or pre-selected communications protocol and the mapping scheme. In addition, the energy operation control unit 540 may transmit the processed measurement information, control status and various sensing information to the user monitoring unit 600 in real time, so that the information can be displayed on the screen of the user monitoring unit 600.

As shown in FIG. 2, the energy operation control unit 540 includes a data transmission/reception unit 541, a data processing unit 542, a real time DB 243, a database 544, an algorithm setting unit 546, a logic control circuit 545, an interface 547, a configuration unit 548, and a protocol setting unit 549.

The data transmission/reception unit 541 transmits/receives the sensing information, electric energy information and the control signals to/from each of the other information measuring unit 510, the energy managing unit 520 and the battery control unit 530. The data transmission/reception unit 541 transforms the sensing information and the electric energy information received from each of the other information measuring unit 510, the energy managing unit 520 and the battery control unit 530 so that they conform to the communications protocol setting information and the mapping information provided from the protocol setting unit 549 to transmit it to the data processing unit 542. When control signals for controlling the other information measuring unit 510, the energy managing unit 520, and the battery control unit 530 are received via the data processing unit 542, the data transmission/reception unit 541 transforms the control signals so that they conform to the communications protocol setting information and the mapping information to transmit them to the energy managing unit 520 and the battery control unit 530.

The data processing unit 542 sorts the sensing information and the electric energy information received via the data transmission/reception unit 541 into one to be stored in the real time DB 243 and one to be stored in the data base 544. The sensing information and the electric energy information are sorted based on whether how its history is managed. The data necessary to be managed for a long period of time is stored in the database 544, while the data necessary to be managed for a short period of time is stored in the real-time DB 243.

The algorithm setting unit 546 stores therein a predetermined power utilization algorithm for using the energy from the power generating unit 100, the battery unit 200 and the external power source 300. In addition, the algorithm setting unit 546 shares the power utilization algorithm selected by the user monitoring unit 600 or the configuration unit 548 with the logic control circuit 545.

The logic control circuit 545 transmits to the user monitoring unit 600 the measurement information, control status and sensing information of the other information measuring unit 510, the energy managing unit 520, and the battery control unit 530 via the configuration unit 548. To this end, the logic control circuit 545 sets and applies notification setting information, data extraction setting information, necessary data storage setting function, etc. so that the control status of each of the units can be displayed on the screen of the user monitoring unit 600. That is, the logic control circuit 545 applies the notification setting information, data extraction information and the necessary data stage setting information to create control status of the other information measuring unit 510, the energy managing unit 520 and the battery control unit 530 so that the control status can be transmitted to the user monitoring unit 600.

Specifically, the logic control circuit 545 determines which measurement information, control status, and sensing information are to be selected and displayed, to which step the information alarm and alert step is set, and how to notify the user monitoring unit 600 when a certain alarm level is reached based on according to the notification setting function of the notification setting unit. In addition, based on the data extraction function of the data extraction setting unit, the logic control circuit 545 determines what kind of control status is to be displayed, how long to set the cycle, and in which format information is extracted and displayed.

By selecting a data storage setting function of the data storage setting unit, data may be printed or saved in a file in a certain format if it is determined that the user can be inferred from control status from the data or the system has to be monitored at periodic interval such as every hour, day, week, month or year.

In addition, application program information of the logic control circuit 545 may be extended and added within the processing range of the logic processor. The logic circuit may include operation main logic, safety logic, communications logic, and the like. Although utilization main logic is described as an example of the logic circuit in the exemplary embodiment, other logics may be applied by modifying them depending on the elements and the type of electricity meter.

The logic control circuit 545 may selectively read the power utilization algorithm via the interface 547 and may control separately the energy managing unit 520 and the battery control unit 530 according to the read power utilization algorithm. The power utilization algorithm may predict the electric power generated by the power generation unit 100 and the demand of the load 400 at predetermined intervals, and may control the energy transfer of the power generation unit 100, the charging/discharging of the battery unit 200 and the energy supply of the external power source 300 at predetermined intervals. The logic control circuit 545 generates control signals for controlling the electricity supply and demand of the power generation unit 100, the battery unit 200 and the external power source 300 according to the power utilization algorithm. In addition, the logic control circuit 510 sends the control signals to each of the other information measuring unit 510, the energy managing unit 520 and the battery control unit 530 so that the electricity supply and demand of the power generation unit 100, the battery unit 200 and the external power source 300 is controlled.

The configuration unit 548 processes the measurement information, control status and sensing information of each of the other information measuring unit 510, the energy managing unit 520 and the battery control unit 530 so that they conform to the communications protocol and the mapping scheme and transmit them to the user monitoring unit 600.

The protocol setting unit 549 supports the communications protocol setting and data mapping information to the data transmission/reception unit 541 and the configuration unit 548. Accordingly, the configuration unit 548 processes the measurement information, the control status and the various sensing information of each of the other information measuring unit 510, the energy managing unit 520 and the battery control unit 530 so that they conform to the communications protocol and the mapping scheme, to transmit them to the user monitoring unit 600.

It is easy to add, change or remove functions to or from the system by the configuration unit 548 if the energy capacity managed by the system is limited to households.

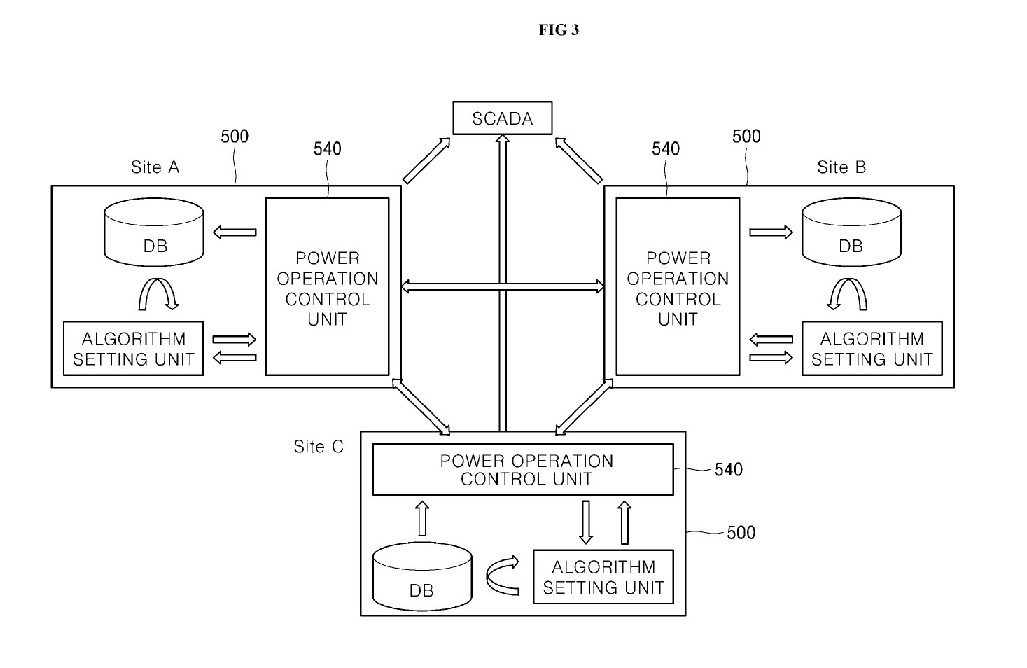

FIG. 3 is a block diagram showing a plurality of system for integrally managing electric energy connected to one another.

As shown in FIG. 3, when the systems are distributed in a plurality of sites Site A to Site C deployed across several regions or areas, respectively, the integrated management controllers 500 of the respective sites Site A to Site C may be connected to one another via the user monitoring unit 600 and a separate SCADA.

The integrated management controllers 500 in the sites Site A to Site C may share all of the information on the electric energy supplied to the load 400 from the power generation unit 100, the information on the electric energy of the battery unit 200, the information on the electric energy supplied from the battery unit 200 to the load 400, the information on the electric energy supplied from the external power source 300 to the battery unit 200, the information on the electric energy transfer from the external power source 300 to the load 400, and information sensed via a variety of sensors, with the user monitoring unit 600 and the SCADA.

As the integrated management controllers 500 of the respective sites Site A to Site C integrally manage the energy utilization of the sites in this manner, the risks due to time synchronization and loss of communications between communications lines can be reduced, such that a variety of elements can be easily connected to one another. In particular, the number of communications lines for transmitting and receiving sensing information, control information and management information required by each of the sites Site A to Site C can be reduced, and accordingly the elements such as the communications modules and synchronization units can be simplified. As a result, the cost for management and maintenance can be saved, and the manpower for managing electric energy can be reduced.

As set forth above, according to the exemplary embodiments of the present disclosure, it is possible to integrally and efficiently manage the energy generated by photovoltaic generation, the stored energy, the energy supplied to the load, and the energy supplied from the external power source, to improve the accuracy and reliability.

In particular, by appropriately selecting and applying energy management and utilization algorithms, it is possible to increase the efficiency of the energy management and to thereby increase the gain.

Although the present disclosure has been described with reference to the exemplary embodiments, those skilled in the art will appreciate that various modifications, additions and substitutions are possible without departing from the scope and spirit of the disclosure defined by the claims.

What is claimed is:

1. A system for integrally managing electric energy comprising:
a power generation unit configured to generate electric energy by photovoltaic generation;
a battery unit configured to charge batteries therein with the electric energy from the power generation unit or electric energy from an external power source or to discharge the electric energy to a load; and
an integrated management controller configured to control an energy transfer path of the power generation unit and the charging/discharging of the battery unit according to a predetermined power utilization algorithm and to support a user monitoring unit so that energy management status is monitored thereon.

2. The system of claim 1, wherein the integrated management controller controls at least one of electric energy supplied to the load from the power generation unit, electric energy charged in the battery unit, electric energy supplied to the load from the battery unit and electric energy supplied to the battery unit from the external power source according to a predetermined energy management algorithm or energy management policy, and supports the user monitoring unit so that control status of the at least one of the electric energy is monitored thereon.

3. The system of claim 1, wherein the integrated management controller comprises:
an other information measuring unit;
an energy managing unit configured to measure and control the electric energy transferred from the power generation unit and the external power source to the load;
a battery control unit configured to measure the electric energy charged/discharged to/from the battery unit and control charging/discharging operations; and
an energy operation control unit configured to control the other information measuring unit, the energy managing unit and the battery control unit according to a predetermined power utilization algorithm and transmit control status of the other information measuring unit, the energy managing unit and the battery control unit to the user monitoring unit.

4. The system of claim 3, wherein the integrated management controller comprises:
a data transmission/reception unit configured to transmit/receive sensing information, electric energy information and a control signal to/from each of the other information measuring unit, the energy managing unit and the battery control unit;
a data processing unit configured to selectively store the sensing information, the electric energy information and the control signal of each of the other information measuring unit, the energy managing unit and the battery control unit in a real-time DB and a database;
an algorithm setting unit configured to store the predetermined power utilization algorithm therein; and
a logic control circuit configured to generate control status on the other information measuring unit, the energy managing unit and the battery control unit so that the control status is transmitted to the user monitoring unit.

5. The system of claim 4, wherein the energy operation control unit comprises:
a configuration unit configured to provide the control status on each of the other information measuring unit, the energy managing unit and the battery control unit received from the logic control circuit and a variety of sensing information items to the user monitoring unit so that they are displayed thereon; and
a protocol setting unit configured to support communications protocol setting information and mapping information for the data transmission/reception unit and the configuration unit.

6. The system of claim 5, wherein the configuration unit processes the measurement information, the control status and the sensing information on each of the other information measuring unit, the energy managing unit and the battery control unit so that they conform to the communications protocol setting information and the mapping information of the protocol setting unit and provides them to the user monitoring unit.

7. The system of claim 4, wherein the logic control circuit selectively reads a predetermined power utilization algorithm via an interface, and controls each of the other information measuring unit, the energy managing unit and the battery control unit according to the selectively read power utilization algorithm.
